(19) United States
(12) Patent Application Publication
(10) Pub. No.: US 2009/0144277 A1
(43) Pub. Date: Jun. 4, 2009

(54) ELECTRONIC TABLE OF CONTENTS ENTRY CLASSIFICATION AND LABELING SCHEME

(75) Inventors: OREN TRUTNER, KIRKLAND, WA (US); BODIN DRESEVIC, Belgrade (RU); SASA GALIC, Belgrade (CZ); BOGDAN RADAKOVIC, Kladovo (CZ); ALEKSANDAR UZELAC, Krusevac (CZ); DEJAN LUKACEVIC, Belgrade (CZ)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/949,501

(22) Filed: Dec. 3, 2007

(51) Int. Cl. G06F 17/27; G06F 17/30

(52) U.S. Cl. 707/6; 707/102; 707/E17.098

(57) ABSTRACT

Computer-storage media, computerized methods and systems for classifying character strings within electronic documents are provided. Initially, textual data, which includes one or more character strings, is extracted from an electronic version of a document, typically scanned from a physical document utilizing optical character recognition. The textual data is received at a table-of-contents (TOC) engine that extracts semantic information from the textual data. Sub-engines within the TOC engine analyze the semantic information to determine at least one appropriate classification for character strings within the textual data. Labels selected from a predetermined set of TOC-architecture labels are appended to the character strings according to the appropriate classification. The character strings, and labels appended thereto, are stored in association with each other generating an electronic document file that includes enriched textual data.

### BACKGROUND

Presently, the Internet provides a vast variety of utilities that assist Internet users in researching, shopping for books, or downloading information. One such utility includes online libraries that contain a large scope of sources of information that are searchable for a desired target document. One increasingly popular method for expanding these sources of information that are available to Internet users is scanning printed documents to an electronic version. This electronic version may be stored as a data file and uploaded to a web site. Typically, during scanning, an image of one or more printed pages are extracted from the document. The image generally has no characters, text, or punctuation delimiters embedded therein. Thus, these images have severely limited searchable content.

Recently, technology has provided for a simplistic document recognition procedure that discerns textual data from a scanned image; however, the textual data is limited to identifying characters, their position on the document page, and, with more advanced recognition software, words that the identified characters create. One common example of recognition software is Optical Character Recognition (OCR). The scanned data files produced by OCR assist users, upon initiating a keyword search on the Internet, in finding uploaded documents and corresponding locations therein.

But, searching for these unsophisticated electronic versions of documents is cumbersome, leading a search engine toward false positive matches, where the topic of the document is unrelated to the word located therein, or toward burying a desirable document as a low-ranked result in the returned results. Additionally, navigating through these electronic versions is a time consuming task where an Internet user may have to visually review many pages in order to find a relevant portion of the online document. Interestingly however, a common feature inherent to most documents is a table of contents that, if provided in a useful format, can assist in increasing the relevance of a search.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for classifying character strings of a table-or-contents (TOC) portion of an electronic document. Image-scanning devices employ technology (e.g., optical character recognition) for identifying textual data on a page of an electronic document, typically scanned from a physical book or article. Upon receiving textual data (for instance, character strings, position of the character strings, and layout and/or shape characteristics of the character strings) extracted from the electronic document, semantic information may be extracted, through a series of tests, from the textual data. This semantic information may be utilized to determine a classification of character strings within the electronic document, typically via a scoring mechanism. The classification may include appending a label to the character strings and storing. In this regard, the stored classification of the character strings enriches the electronic document with format information that enhances navigation thereof. In this way, the classified character strings may be advantageously leveraged to improve relevance of keyword searches over the Internet.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary book layout system configured to determine the layout of an electronic version of a document, in accordance with an embodiment of the present invention;

FIG. 3 is a block diagram of an exemplary table-of-contents (TOC) engine configured to classify character strings within TOC entries, in accordance with an embodiment of the present invention;

FIG. 4 is a flow diagram illustrating an exemplary method for classifying character strings of a TOC portion of an electronic document, in accordance with an embodiment of the present invention;

FIGS. 5-8 are exemplary images portraying TOC portions of electronic documents, in accordance with embodiments of the present invention;

FIG. 9 is an exemplary image portraying a TOC portion of an electronic document with a histogram overlay, in accordance with an embodiment of the present invention;

FIGS. 10-14 are exemplary images portraying TOC portions of electronic documents, in accordance with embodiments of the present invention;

FIG. 15 is a flow diagram illustrating an exemplary method for determining which label, of a predetermined set of TOC-architecture labels, to append to a character string, in accordance with an embodiment of the present invention; and

FIG. 16 is a flow diagram illustrating an exemplary method for verifying the identity of the TOC entries, in accordance with an embodiment of the present invention;

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems, and computer-storage media having computer-executable instructions embodied thereon, for classifying character strings of a table-or-contents (TOC) portion of an electronic document. Image-scanning devices employ technology (e.g., optical character recognition) for identifying textual data on a page of an electronic document, typically scanned from a physical book or article. Upon receiving textual data (for instance, character strings, position of the character strings, and layout and/or shape characteristics of the character strings) extracted from the electronic document, semantic information may be extracted, through a series of tests, from the textual data. This semantic information may be utilized to determine a classification of character strings within the electronic document, typically via a scoring mechanism. The classification may include appending a label to the character strings and storing. In this regard, the stored classification of the character strings enriches the electronic document with format information that enhances navigation thereof. In this way, the classified character strings may be advantageously leveraged to improve relevance of keyword searches over the Internet.

Accordingly, in one aspect, the present invention provides one or more computer-storage media having computer-executable instructions embodied thereon that, when executed, perform a method for classifying character strings of a TOC portion of an electronic document. The method includes receiving textual data extracted from the electronic document; extracting semantic information from the textual data; executing a classification procedure to determine an appropriate classification for the character strings by analyzing the semantic information; appending labels selected from a predetermined set of TOC-architecture labels to the character strings according to the semantic information; and storing the labels in association with the character strings. The classification procedure further includes performing categorization tests that utilize the extracted information, and calculating at least one score based on the results of the categorization test(s).

In another aspect of the present invention, a computer system is provided for determining a structure of a TOC portion of an electronic document. The computer system includes a converter component; a TOC engine, including a featurizer tool and an word-label sub-engine; and a merge engine. The converter component is for receiving textual data extracted from TOC pages of the electronic document. The TOC engine is for classifying elements within the TOC entries of the electronic document. The featurizer tool is for extracting semantic information from the textual data. The word-label sub-engine is, in part, for determining at least one appropriate classification for the elements by analyzing the semantic information, and for appending labels to the elements according to the at least one appropriate classification. The merge engine is for storing the labels in association with the elements.

A further aspect of the present invention provides a computerized method for classifying character strings within electronic documents. The method includes receiving textual data extracted from an electronic document, where the textual data includes character strings; deriving semantic information from the textual data; analyzing the semantic information to determine at least one appropriate classification for the character strings; appending labels to the character strings according to at least one appropriate classification; and serializing the label(s) in association with the character string(s) in an output file. In embodiments, the method further includes selecting labels the appended labels from a predetermined set of TOC architecture labels, bibliography architecture labels, or index architecture labels.

Having briefly described an overview of embodiments of the present invention, an exemplary operating environment suitable for implementing the present invention is described below.

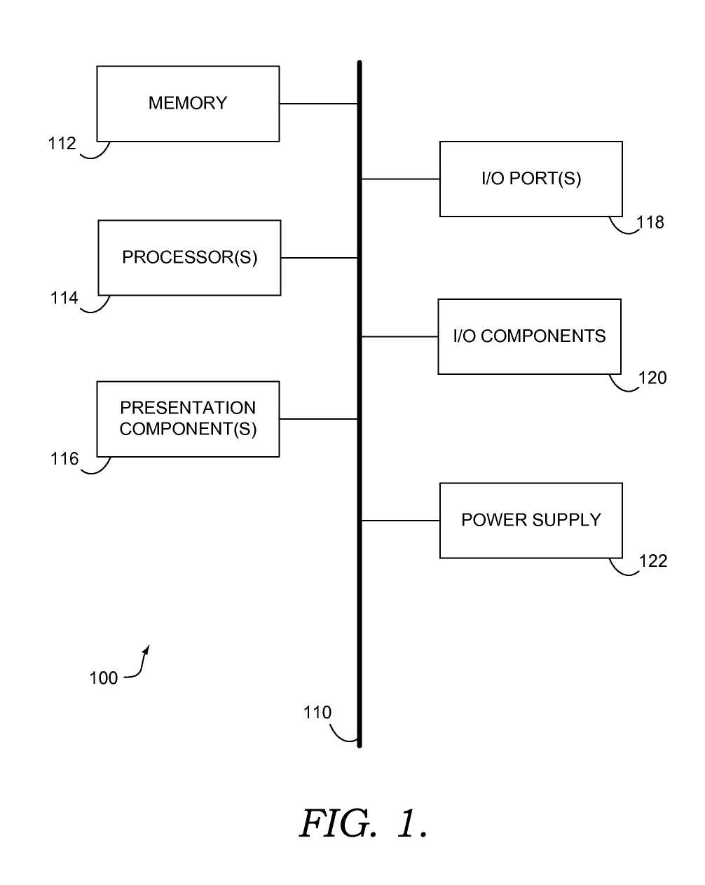

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

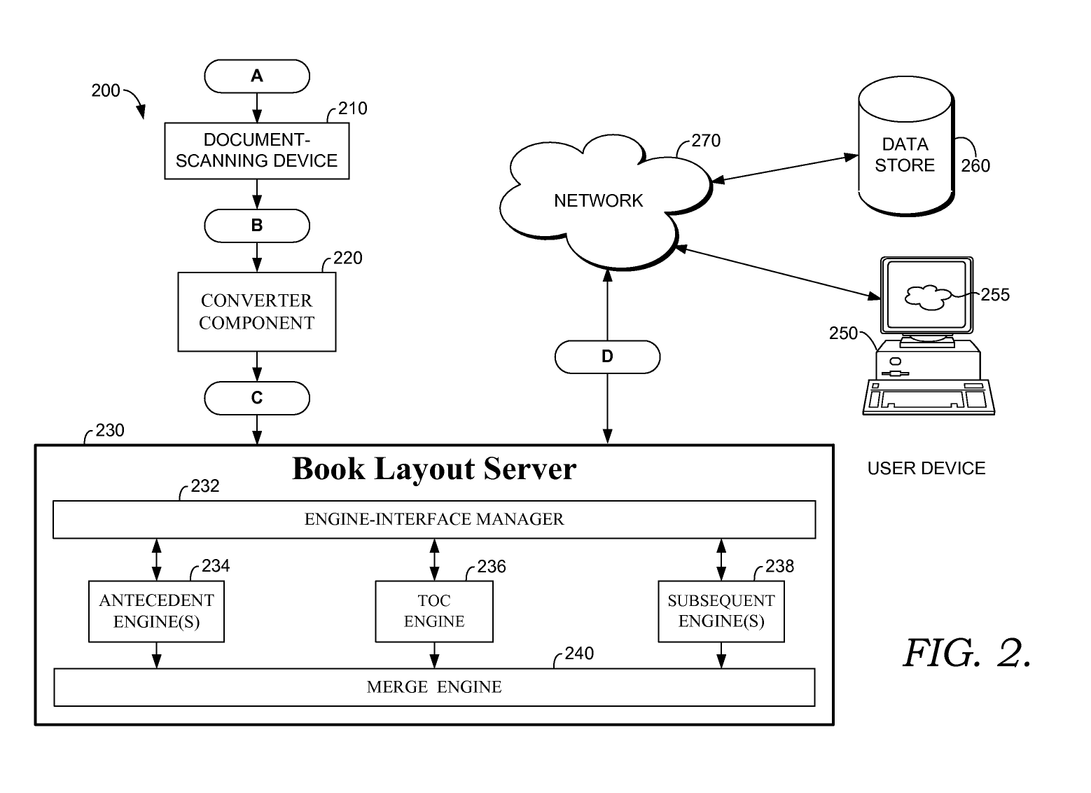

Turning now to FIG. 2, a block diagram is illustrated showing an exemplary book layout system 200 configured to determine a structure of a table-of-contents (TOC) portion of an electronic document, in accordance with an embodiment of the present invention. It will be understood and appreciated by those of ordinary skill in the art that the book layout system 200 shown in FIG. 2 is merely an example of one suitable computing environment and is not intended to suggest any limitation as to the scope of use or functionality of the present invention. Neither should the book layout system 200 be interpreted as having any dependency or requirement related to any single component or combination of components illustrated therein. Further, the book layout server 230 may be provided as a stand-alone product, as part of a book layout software package, or any combination thereof.

Book layout system 200 includes a document scanning device 210, a converter component 220, a book layout server 230, a user device 250, and a data store 260, all in communication with one another via a network 270. The network 270 may include, without limitation, one or more local area networks (LANs) and/or wide area networks (WANs). Such networking environments are commonplace in offices, enterprise-wide computer networks, intranets, and the Internet. Accordingly, the network 270 is not further described herein.

The document-scanning device 210 is configured to receive an electronic version of a document (e.g., electronic document A), and acquire raw textual data (e.g., raw textual data B) therefrom. Typically, the electronic document A is extracted from a physical document (e.g., book, article, bound reference material, or any other paper-based literature) by utilizing a scanner or other photo-copying mechanism to capture scanned images. Next, the document-scanning device 210 acquires the textual data B utilizing optical-character-recognition (OCR) technology that translates scanned images within the electronic document A into textual data B, which is machine-readable text. In one embodiment, the textual data B includes characters, their coordinate position within the scanned image, and, in some instances, character strings assembled from individual identified characters. In other embodiments, the textual data B may include one or more of the following: position values associated with the one or more character strings (on a page of the electronic document); and layout characteristics, and shape characteristics, of the one or more characters strings. Textual data may include any content information of a primitive level, such as lines of text, words within the lines, letters within the words, pictures within the content, and the like.

The converter component 220 is configured to translate the textual data B into an input file that may be easily processed by the book layout server 230. Because there exists a variety of document-scanning devices 210, the resultant textual data B may be stored as one of a variety of formats of metadata. Accordingly, the converter component 220 is able to receive these various formats of metadata and implement a conversion process that interprets the metadata and writes an input file having a basic, or “vanilla,” optical character recognition markup language (OCRML) format C. The OCRML format C may be consumed by book layout server 230 free from dependency on any particular format, and includes a representation of the textual data B acquired from document-scanning device 210. That is, the OCRML format C includes a representation of the textual data utilized by the book layout server 230 to perform a layout analysis, as more fully discussed below. In one embodiment, the OCRML format C may be based on textual data B extracted from an international electronic document A written in a foreign language. In this instance, the book layout server 230 is adapted to recognize and process the foreign language OCRML format C utilizing language indices that correspond thereto.

The book layout server 230 is configured to receive the OCRML format C as an input, perform an extraction of layout metadata and store the extracted layout metadata together with the OCRML format C as a resulting output file D. In one embodiment, the book layout server 230 executes computer-readable media that perform the functions above as a single complex application. In an exemplary embodiment, the book layout server sever 230 executes the functions above by performing a sequence of routines at specialized, modular engines. In particular, the book layout server 230 employs antecedent engine(s) 234, a table-of-contents (TOC) engine 236, subsequent engine(s) 238, an engine-interface manager 232, and a merge engine 240 to perform the functions above. The engine-interface manager 232 is configured to transfer layout metadata, as extracted by the engines 234, 236, and 238, between components of the book layout server 230. In one instance, as discussed more fully below, the TOC engine 236 extracts semantic information from the OCRML format C, which is incorporated into the layout metadata. The merge engine 240 is configured to integrate the extracted layout metadata of the engines 234, 236, and 238 into the resulting output file D. In one embodiment, the output file D is formatted as book markup language that is readable by the user device 250 and/or stored in association with the data store 260.

The antecedent engine(s) 234 include one or more modular engines that perform a sequence of operations to extract layout information prior to, or coincident with, the TOC engine 236. This layout information helps define hierarchical structures within the electronic document, which may assist the operation of the TOC engine 236. One exemplary antecedent engine 234 is a “title detection engine” that detects the page titles (discussed below) of a scanned electronic document. An example of a title may be “Table of Contents” on a table-of-contents page of an electronic version of a book, where the titles may be detected based on boldness, font, character height, and other attributes included in the textual data that distinguish a title. Another exemplary antecedent engine 234 is a “page classifier engine” that classifies the pages, or portions of a page, of an electronic document by utilizing the textual data. In one instance, the page classifier engine may classify a section of the electronic document as a table-of-contents (TOC) portion. Yet, another exemplary antecedent engine 234 is a “page number engine” that extracts page number information from at least one page of the electronic document. Advantageously, page number information allows a table-of-contents (TOC) entry to map to a target section of the electronic document thereby linking the TOC entries to corresponding page content.

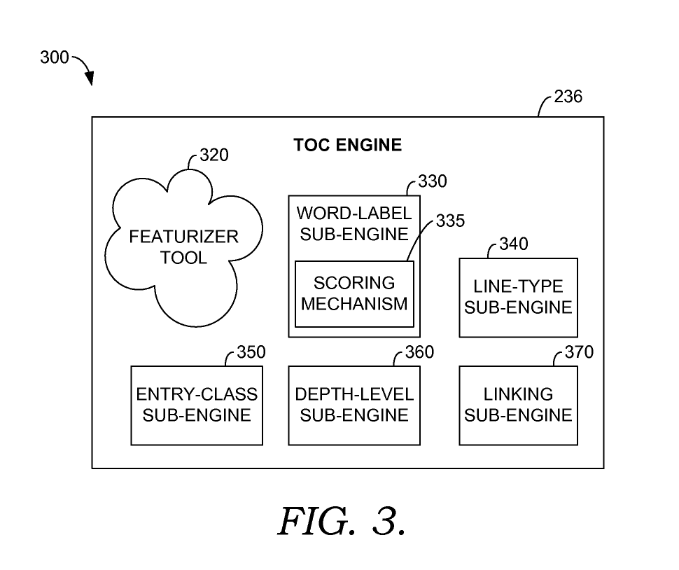

The subsequent engine(s) 238 include those modular engines that perform a sequence of operations to extract layout information after, or coincident with, the TOC engine 236. Accordingly, the subsequent engine(s) 238 may perform operations that utilize enriched data that is extracted and transferred by the TOC engine 236, discussed more fully below with reference to FIG. 3. The potential functions carried out by the subsequent engine(s) 238 are not further described herein as they are outside the scope of the present invention.

The user device 250 may take the form of various types of computing devices (e.g., computing device 100). By way of example only, the user device 250, as well as document-scanning device 210, the converter component 220, and the book layout server 230, may be a personal computing device, handheld device, consumer electronic device, and the like. Additionally, the user device 250 is configured to present a user interface 255 and, in embodiments, to receive input in one embodiment. The user interface 255 may be presented on any presentation component (not shown) that may be capable of presenting information to a user. In an exemplary embodiment, the user interface 255 presents a navigation interface that represents a table of contents of an electronic version of a document, where the navigation interface allows a user to jump to page content that corresponds with a TOC entry upon the user selecting a link embedded within the TOC entry. Further, the user interface 255, in another embodiment, presents a web browser interface that allows a user to enter a search query in order to find information stored in association with the data store 260.

The data store 260 is configured to store information that is searchable upon a user request. In embodiments, such information may include, without limitation, output file information that is formatted as book markup language and is readable by the data store 260. In one instance, the output file information will affect a search result provided in response to a search query by giving a higher preference to electronic documents with terms or entries within the table of contents matching the search query. It will be understood and appreciated by those of ordinary skill in the art that the information stored in the data store 260 may be configurable, and may store any information relevant to output file information generated by the book layout server 230. The content and volume of such information are not intended to limit the scope of embodiments of the present invention in any way. Further, though illustrated as a single, independent component, data store 260 may, in fact, be a plurality of databases, for instance, a database cluster, portions of which may reside on a computing device associated with the book layout server 230, the user device 250, another external computing device (not shown), and/or any combination thereof.

As shown in FIG. 3, the TOC engine 236 is configured to classify elements within a TOC portion of an electronic document, e.g., electric document A. In the illustrated embodiment, the TOC engine 236 includes a featurizer tool 320, a word-label sub-engine 330, a line-type sub-engine 340, an entry-class sub-engine 350, a depth-level sub-engine 360, and a linking sub-engine 370. In some embodiments, one or more of the illustrated components may be implemented as stand-alone applications. In other embodiments, one or more of the illustrated components may be integrated directly into the operating system of the book layout server 230 (see FIG. 2) and/or the user device 250 (see FIG. 2). It will be understood by those of ordinary skill in the art that the components illustrated in FIG. 3 are exemplary in nature and in number and should not be construed as limiting. Any number of components may be employed to achieve the desired functionality within the scope of embodiments of the present invention. Further, in one embodiment, the components of the TOC engine 236 are reliant on received information such that the result of the one component depends on the results of the previous components. In another embodiment, dependent components may attempt to correct the results being passed thereto by considering external information in addition to previous component results. All such variations, and any combination thereof, are contemplated to be within the scope of the present invention.

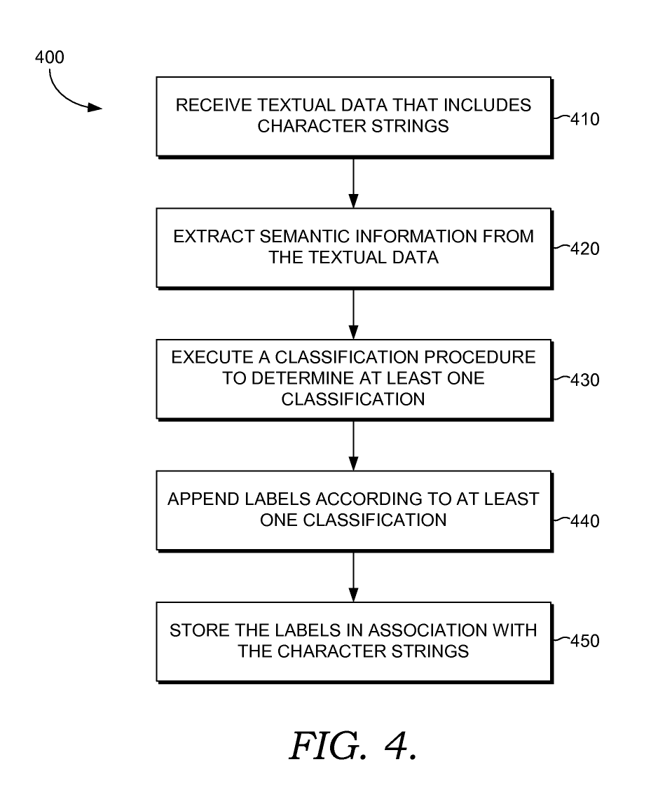

The general functionality of the TOC engine 236 (see FIG. 3) will now be discussed with reference to FIG. 4, wherein a flow diagram is illustrated showing an exemplary method 400 for classifying character strings of a TOC portion of an electronic document. Initially, textual data is received that includes, at least, character strings, as depicted at block 410. Semantic information is then extracted from the textual data, as indicated at block 420. As indicated at block 430, a classification procedure is executed to determine at least one classification. Labels are appended to the character strings according to the at least one classification, as indicated at block 440. The character strings and the labels appended thereto are stored in association with each other, as indicated at block 450. Although illustrated as being performed by the TOC engine 236 (see FIG. 3) for purposes of discussion herein, method 400 may be carried out by other engines within the book layout server sever 230 (see FIG. 3), and is not limited to TOC entries. By way of example, and not limitation, method 400 may be applied to classifying character strings within the context of a bibliography or index, and may be expanded to applying labels selected from a predetermined set of bibliography architecture labels or index architecture labels, respectively.

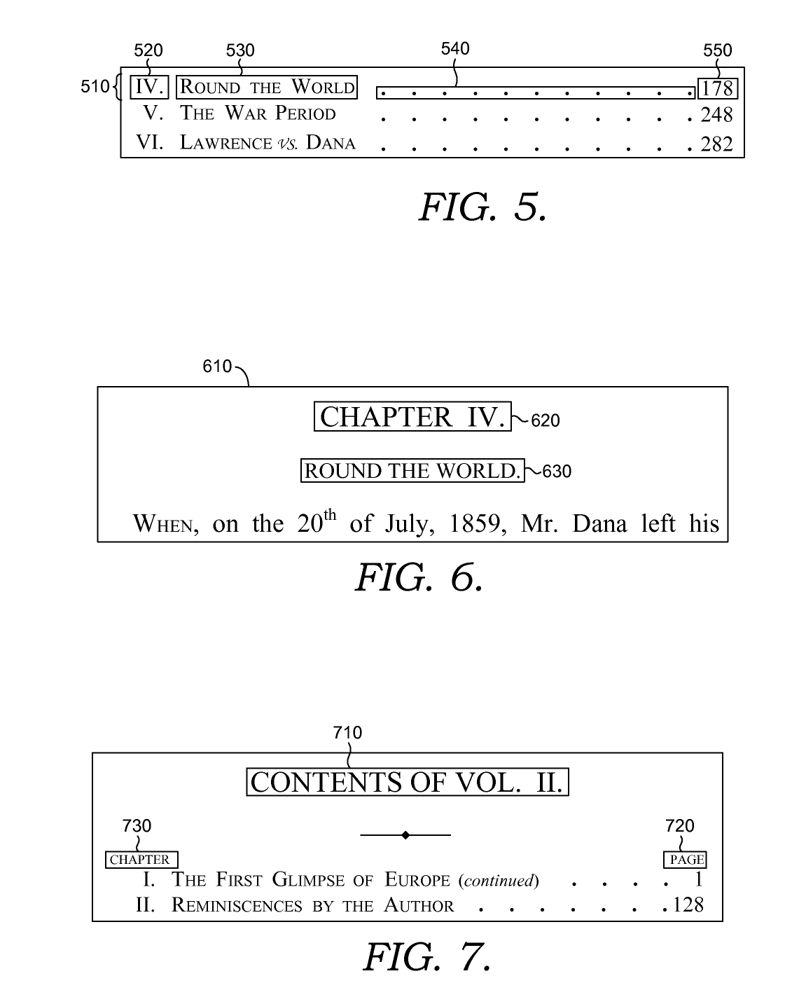

At this point, TOC entries and the elements that comprise TOC entries will be introduced. Typically, a TOC entry is a single reference to a target section (part, chapter, line, words in a line, etc.) somewhere in the main body of an electronic document. A depiction of a TOC entry is shown on FIG. 5 at reference numeral 510. In this instance, the TOC entry 510 includes one or more elements, as indicated by reference numerals 520, 530, 540, and 550, that make up the structure of the TOC entry 510. In embodiments, the elements 520, 530, 540, and 550 may be character strings. Based on the textual data associated with these character strings, the TOC engine 236 may identify each element as belonging in a particular classification. With continued reference to FIG. 5, the illustrated elements 520, 530, 540, and 550 may be classified as a “chapter name number” (IV), a “chapter title” (ROUND THE WORLD), a “chapter separator” ( . . . ) and a “chapter page number” (178), respectively. These classifications may be a subset of the TOC-architecture labels, as will be discussed more fully below with reference to the word-label sub-engine 330 (see FIG. 3).

Returning to FIG. 3, the featurizer tool 320 is configured for extracting semantic information from the textual data. As discussed above, the textual data is provided in an input file to the book layout server 230 in OCRML format. In one embodiment, an intermediate OCRML format that includes layout metadata, typically derived by antecedent engine(s) 234 and transferred to the TOC engine 236 via the engine-interface manager 232, is utilized for extracting semantic information. For instance, the layout metadata may include structural information that identifies the TOC portion of the electronic document.

Initially, the featurizer tool 320 attempts to extract semantic information, which includes individual features, from the textual data. Typically, extracting semantic information includes organizing character strings and/or lines of character strings into groups based on their associated textual data, such as shape characteristics or layout characteristics of the character strings. In an exemplary embodiment, an alignment feature, a word height feature, a character width feature, and a vertical indention feature comprise the initial semantic information that is extracted by the featurizer tool 320. Each of these features is described more fully below.

The alignment feature may be extracted upon determining whether a line of character strings is left aligned, right aligned, center aligned, laterally justified, or having no alignment. Further, the alignment feature allows the featurizer tool 320 to derive a position of the page margin, for both the right and left sides of the page.

The word-height feature may be extracted upon determining the height of the character strings in the TOC portion, averaging the character strings per line and/or page, and comparing the averaged values to individual character strings and lines in the TOC portion. The classifications within the word height feature may include classifying a line into one of the following predefined groups: small, below median, median size, above median, big, and none. A word-height histogram may be employed to assist in classifying the character strings and lines into the groups above in the place of averaging. For instance, the 25^{th} and 75^{th} percentile of the character-string height may be determined by a plotting the individual height points on a histogram. Based on these percentiles, the character strings are assigned a low and high boundary. Similarly, the high and low boundaries of the page, based on percentile line heights on a page, may be determined. Upon collecting this information, the two low and two high boundary values (one for page and the other for each line) may be used to perform the following classification: in the case that both low and high line boundaries are below the low boundary for the page, the line is small; in the case that the low line boundary is below the low page boundary, the high line boundary is above low page boundary, and the high line boundary is below high page boundary, the line is below median; in the case that the low line boundary is above the low page boundary, but is below the page high boundary, and the high line boundary is below the high page boundary, the line is of median size; in the case that the low line boundary is above the low page boundary, but below the page high boundary, and the high line boundary is below the high page boundary, the line is above median; in the case that both line boundaries are above the high page boundary, the line is big; and in the case that these criteria are not met, the line is not classified. An additional word height feature, typically extracted from the textual data, is an actual-height boundary of a character string that is determined by measuring the vertical pixels that comprise a particular character within a character string.

The character width feature is a continuous line feature that provides an average character width of the characters that form a character string. The average character width is determined by measuring the number of pixels that extend horizontally within each character of a character string.

The vertical indentation feature is a discrete line feature that classifies a line with respect to its vertical indentation. In this instance, classification includes assigning a line to a group of similar lines according a redefined index. Vertical indention may be determined by measuring the vertical separation between lines.

Upon extracting the above-listed features as semantic information from the textual data, the word-label sub-engine 330 may analyze the semantic information to determine at least one appropriate classification for each of the character strings. Additionally, the word-label sub-engine 330 is configured for appending one or more labels, selected from a predetermined set of TOC-architecture labels, to the character strings according to the determined classification.

The process of determining the appropriate classification is divided into at least two separate principal passes. In the first principal pass, simple patterns are detected within the semantic information associated with the character strings. These patterns are matched against predefined layout and shape characteristics to provide an initial identification of a classification for the character strings.

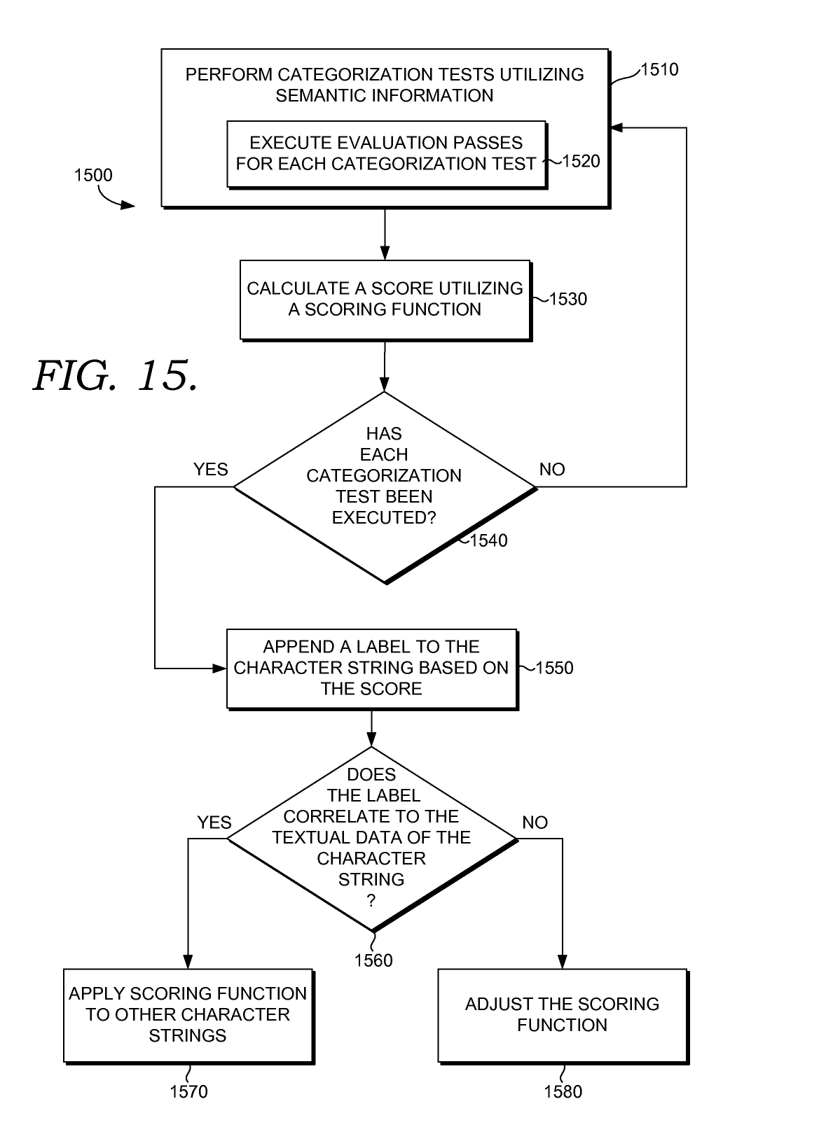

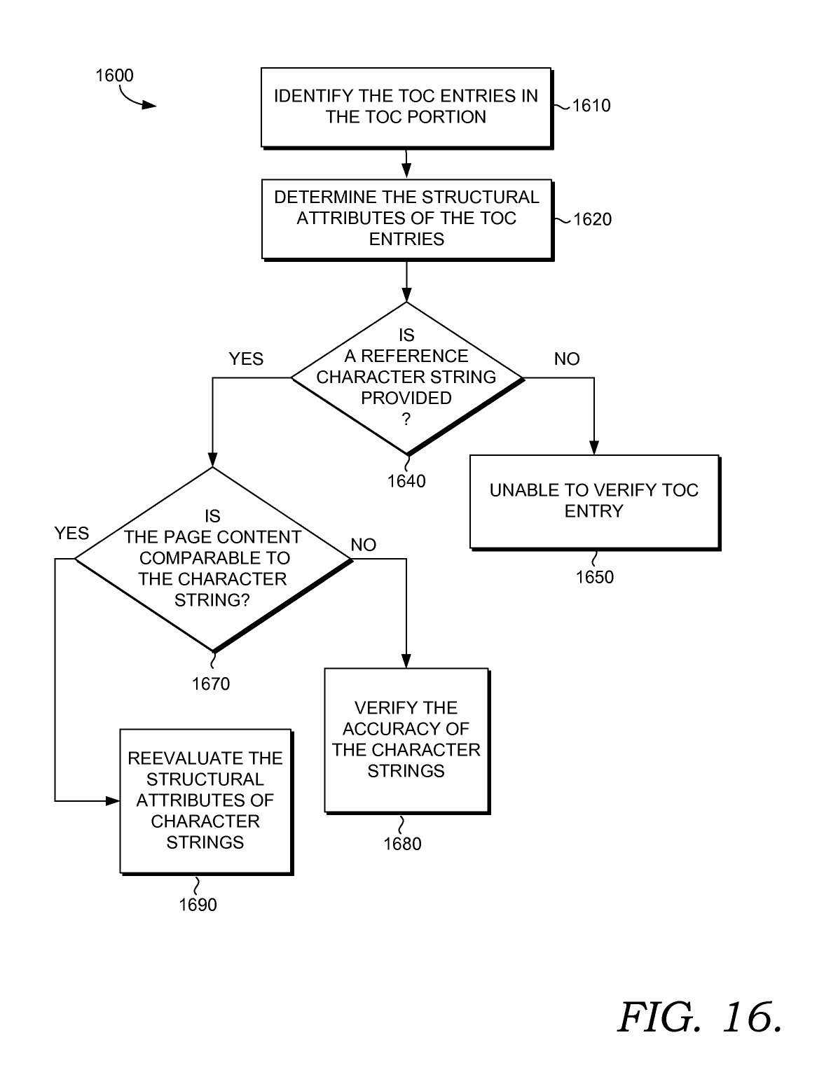

This initial identification of a classification may be determined by executing a classification procedure. With reference to FIG. 15, a flow diagram illustrating an exemplary classification procedure 1500 is shown. Initially, the classification procedure 1500 includes performing one or more categorization tests that utilize the extracted semantic information, as indicated at block 1510. Typically, each of the classification tests relate to a respective label in a predetermined set of TOC-architecture labels. An exemplary list of the TOC-architecture labels includes the following: TOC_TITLE (e.g., page title), TOC_NONE (e.g., negligible text that is not related to content of the TOC page, column page that provides an indication of the horizontal position of chapter page numbers, column name that indicates the horizontal position of chapter name keywords, or column title that indicates the horizontal position of chapter title keywords), TOC_CHAPTER_ADDITION (e.g., titles that appear in the TOC page of the electronic document, within a TOC entry, but not on a target body page), TOC_CHAPTER_NAME (e.g., chapter names like “CHAPTER” and chapter name numbers like “VII”), TOC_CHAPTER_TITLE (i.e., chapter title of each individual chapter), TOC_CHAPTER_SEPARATOR (e.g., chapter separator, typically dots between title and chapter page number), and TOC_CHAPTER_PAGE_NUMBER (e.g., chapter page number, typically arabic numerals of the target page). Additional labels include INTO (e.g., introductory entry), REGULAR (e.g., regular entry), OUTRO, and NONE, as discussed more fully below with reference to entry-class sub-engine 350. Accordingly, each and every identified TOC entry extracted from any book read into an electronic document, by OCR technology, can be labeled according to this labeling scheme of TOC-architecture labels. As such, the listing of TOC-architecture labels, and associated processes for labeling, provide a robust scheme for characterizing the various parts of a character string of any candidate TOC entry.

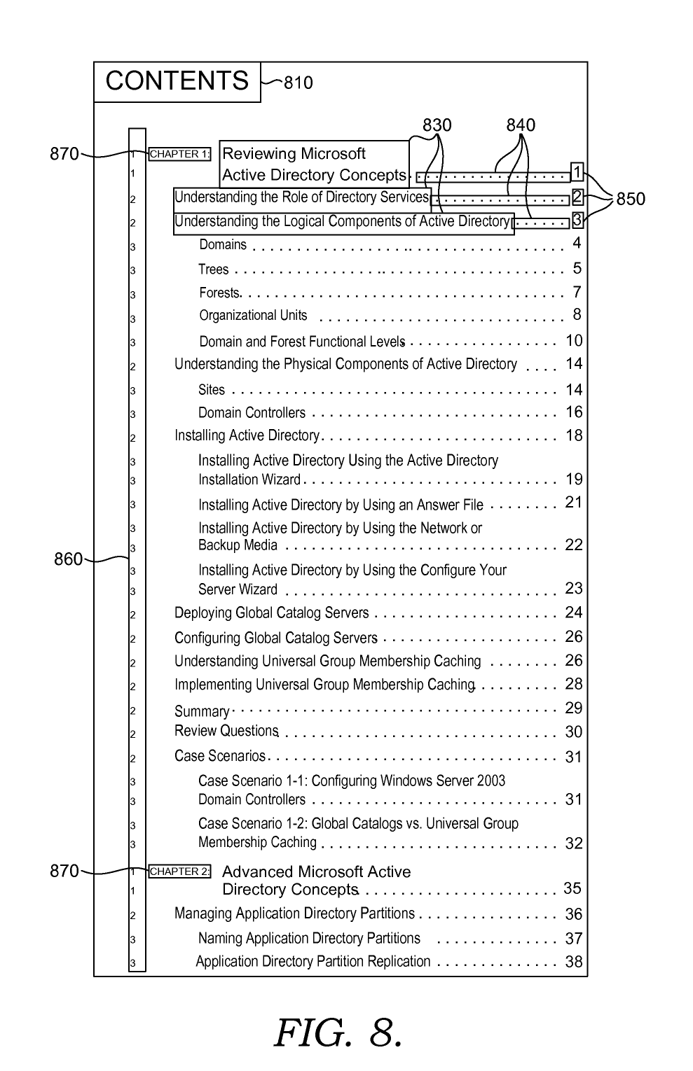

Referring now to FIGS. 7 and 8, classifications associated with TOC-architecture labels are shown. In particular, FIG. 7 depicts a page title as indicated by reference numeral 710, a column page as indicated by reference numeral 720, and a column name as indicated by reference numeral 730. Further, FIG. 8 depicts a page title as indicated by reference numeral 810, chapter titles that are indicated by reference numeral 830, chapter separators that are indicated by reference numeral 840, chapter page numbers that are indicated by reference numeral 850, and chapter names that are indicated by reference numeral 870. Reference numeral 860 is discussed below, with reference to the depth-level sub-engine 360 (FIG. 3).

Returning back to FIG. 15, performing each of the categorization tests in the classification procedure is accomplished by executing one or more evaluation passes of the character strings, as indicated at block 1520. Typically, a score is calculated by a scoring mechanism 335 (see FIG. 3) incident to running a categorization test for the character strings, as indicated at block 1530. In one embodiment, each of the evaluation passes adjust the score incrementally based upon the results generated therein. For instance, if an evaluation pass indicates that the semantic information associated with a particular character string corresponds with a classification associated with the categorization test being performed, the score is boosted by a scoring mechanism. That is, the value of the score for a character string determined by the categorization test(s) indicates a correlation between a label, of the set of TOC-architecture labels, and the character string.

By way of example only, and not limitation, a determination of a score of a page title label will now be described. Initially, the categorization test associated with the page title label is initiated to analyze the semantic information of a particular character string. Next, a set of evaluation passes are performed to incrementally determine a score that is dynamically calculated utilizing the scoring mechanism (e.g., scoring mechanism 335 of FIG. 3). In the first pass, the score is adjusted upward, or boosted, if the character string is located in the first line of the TOC section that has more than a threshold number of alphabetic characters therein. In the second pass, the score is boosted if the character string resides in a line which is center-aligned, as determined by the featurizer tool (e.g., featurizer tool 320 of FIG. 3). In the third pass, the score is boosted if the character string resides in a line with above average word height, e.g., where the word height feature is classified as “big”. Alternatively, boosting may be proportional to the relative difference between the of character string height and the average character string height per page. In the fourth pass, the score is boosted if the average character width feature of the character string is greater than the character width features of character string in other lines. In the fifth pass, the score is boosted if the character string resides in a line with above average character font sizes. In the sixth pass, the score is boosted if the character string resides in a line with all capital letters. In the seventh pass, the score is boosted if the character string has a low relative Levenshtein distance from previously established keywords (e.g., “Contents” or “Table”). Levenshtein distance is a concept known to those of ordinary skill in the art and, accordingly, is not further described herein.

Upon completing each evaluation pass, the score is dynamically adjusted (e.g., by the scoring mechanism 355 of FIG. 3). In one embodiment, the scoring mechanism is a scoring function that receives inputs based on the results of the individual evaluation passes. In one instance, the scoring function is expressed as the following algorithm:

score[n+1]=(score[n]*mulF)+addF,

where n indicates the iterative number of evaluation passes performed, the multiplicative coefficient is mulF, the additive coefficient is addF; and score[n] represents a value of the score upon performing n number of evaluation passes. That is, the value of the score is incrementally reevaluated, utilizing the scoring function, incident to the completion of each of the evaluation passes. In one embodiment, the multiplicative coefficient and the additive coefficient are assigned numerical values based on the significance of the predefined layout and shape characteristics utilized in each evaluation pass as they relate to the overarching classification associated with the categorization test.

Returning now to FIG. 15 when the last evaluation pass is complete, a final value of the score for a particular categorization test is arrived upon and assigned to the character string. Other categorization tests are then performed on the character string, and scores respectively assigned thereto. Once it has been determined that each of the categorization tests has been performed, as indicated at block 1540, the scores are compared against each other and a label is appended to the character string as indicated at block 1550. In one embodiment, the categorization test that established the highest score is identified and the label associated with that categorization test is appended to the character string. For instance, if the scores assigned to a character string upon completing each of the categorization tests were 800 for the test associated with the column title, 50 for the test associated with a chapter separator, and 165 for the test associated with the column number, the column title label would be appended.

Upon appending a label to a character string, a determination of whether the label correlates to the textual data associated with the character string is made, as indicated at block 1560. If the determination indicates that the character string is mislabeled, then the scoring function is adjusted, as indicated at block 1580. In one embodiment, a determination of whether a character string is mislabeled is made upon visual examination. In response, the coefficients of the scoring function may be hand-tuned (i.e., numerically adjusted) to increase the accuracy of the first principal pass. In another embodiment, a determination of whether a character string is mislabeled is made by computerized analysis. In response, the numerical values of the coefficients may be automatically trained according to a machine-learning framework (e.g., neural network implementation) to improve the accuracy of correlation between the appended label and the actual classification of the character string. Advantageously, the multiple evaluation passes and the ability to train the scoring function assist in avoiding mislabeling a character string that may result from OCR errors (e.g., improper alignment or character size) that occurred during initial extraction of textual data. On the other hand, if the character string is labeled correctly, the scoring function is allowed to continue scoring character strings unaltered, as indicated at block 1570.

In the second principal pass, the results of the first pass are reevaluated to further enhance accuracy and remove any potential underlying errors, especially in cases where scores for two labels are comparable. Typically, three steps are performed within the second principal pass. The first step reevaluates the scores associated with the chapter page number label and the chapter name number label by recursively applying supplemental tests. The benefit of applying supplemental tests in this manner relates to the conservative nature of the categorization tests associated with assigning the chapter page number label and the chapter name number label, whereby each is assigned a high score if a sufficiently small relative Levenshtein distance number is calculated.

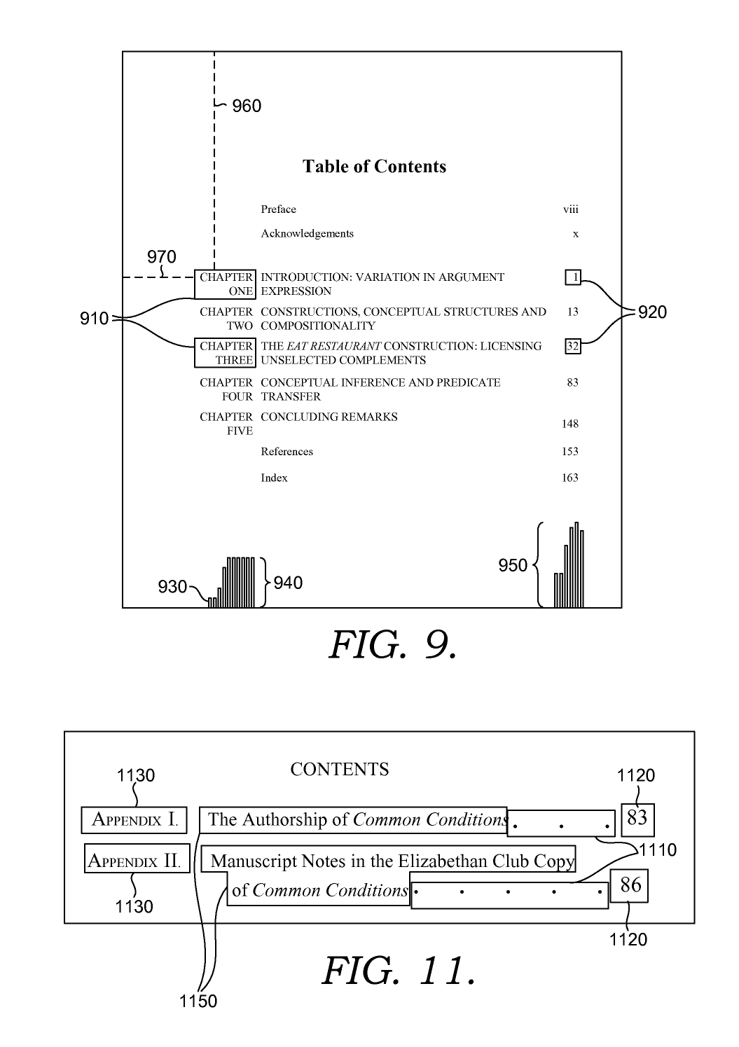

Turning now to FIG. 9, an exemplary image portraying a TOC portion of an electronic document with a histogram overlay, as an example of a first supplemental test, is shown. In the illustrated embodiment, the first supplemental test determines whether the character strings identified as a chapter page number and/or a chapter name number are aligned. As shown, the chapter page numbers 920 and the chapter name numbers 910 are horizontally aligned. This alignment is discovered upon testing the numbers of a certain type with respect to their horizontal position on a page. Horizontal position is derived from a coordinate position of a character sting on a page, provided within the textual data. In the illustrated embodiment, the coordinate position includes a horizontal location 970 and vertical location 960 as measured from the top, left-hand corner of the page. A position histogram may then be created by dividing the horizontal dimension of the page into equidistant bins 930, each having a horizontal location. If the horizontal location for each of the numbers corresponds to the horizontal location of a bin, then an index value within the bin is incremented. In the embodiment illustrated in FIG. 9, the index values for each bin are displayed as representative vertical bars. Where a group of numbers have closely related horizontal locations, the vertical bars form a peak. In this example, peak 940 is associated with the chapter name numbers 910 and peak 950 is associated with chapter page numbers 920. The peaks 940 and 950 substantially verify the classification of the character strings labeled as chapter name numbers 910 and chapter page number 920, respectively, and help expose mislabeled numbers.

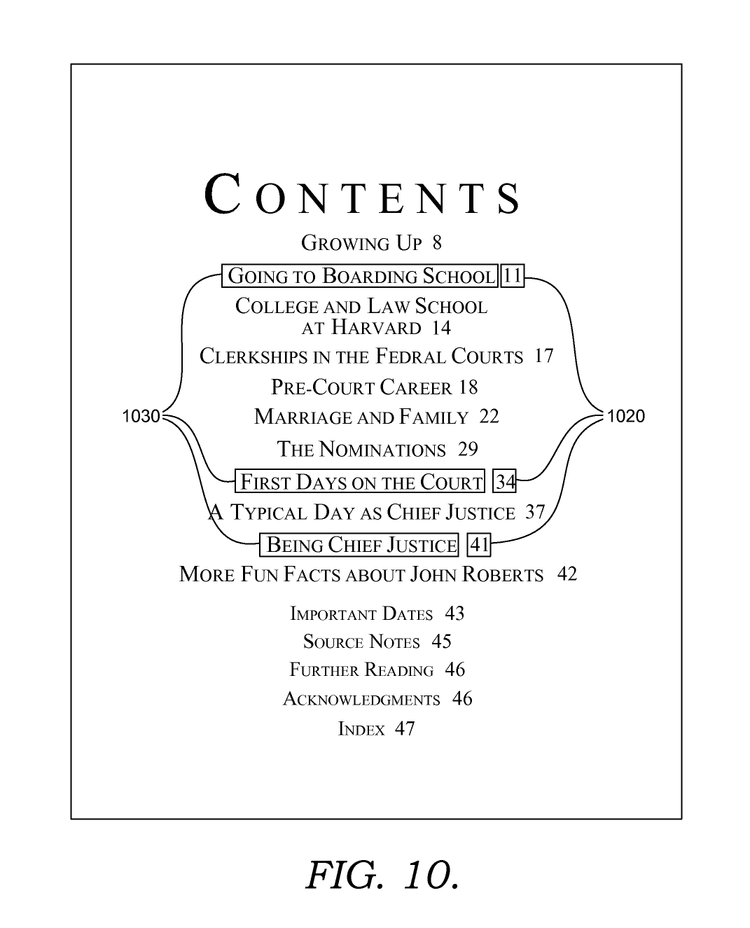

If the first supplemental test within the first step determines that the character strings identified as a chapter page number and/or a chapter name number are not aligned, then a second supplemental test is applied. The second supplement test determines whether the chapter page number and the chapter name number follow a logical position pattern. The logical position pattern is based on the assumption that the numbers are spaced a consistent distance before and after the initial and final characters in a particular line. With reference to FIG. 10, the chapter page numbers 1020 are similarly spaced from the final characters in lines 1030. This determination, similar to the histogram above, substantially verifies the classification of the character strings labeled as chapter name numbers and chapter page numbers 1020.

In a second step of the second principal pass, false negative chapter name number labels are recognized by considering the context of the surrounding character strings. In particular, the labels of the surrounding character string are identified, and if a chapter name number is preceded by a chapter title, then an error indication may be returned. With reference to FIG. 11, chapter name numbers 1130 are shown as being followed by chapter titles 1150. By standard convention in TOC formatting, the order illustrated in FIG. 11 is considered by the TOC engine as invariable. Thus, if a chapter name number 1130 is preceded by a chapter title 1150, the second step will flag both character strings as being misclassified.

In a third step of the second principal pass, non-alpha numeric character strings (e.g., colons, hyphens, semicolon, etc.) that are labeled as a chapter separator and appear in the middle of a line are reevaluated. Referring again to FIG. 11, chapter separators 1120 are typically positioned between chapter titles 1150 and chapter page numbers 1110. By standard convention in TOC formatting, the non-alphanumeric characters that separate chapter titles 1150 are typically punctuation within a single chapter title 1150 and not a chapter separator. Thus, if a chapter separator 1120 was positioned between a set chapter titles 1150, then an error indication may be returned.

Next, with reference to FIG. 16, a flow diagram illustrating an exemplary method for identifying and verifying TOC entries is shown and illustrated as reference numeral 1600. Initially, TOC entries are identified in the TOC portion of the electronic document by the featurizer tool 320 (see FIG. 3), as indicated at block 1610. Identification may include organizing character strings, labeled by the word-label sub-engine 330 (see FIG. 3), according to certain criteria. In one embodiment, the criteria may require that certain classifications of character strings combine to form a TOC entry. For instance, a TOC entry generally includes at least character strings individually labeled as a chapter name, a chapter title, a chapter separator, and a chapter page number. In another embodiment, the criteria may require that the TOC include a single reference character string that maps to a target section of the electronic document. Although, two methods for organizing character strings based on criteria have been described, it should be understood and appreciated that various methods exist to identify TOC entries based on textual data and/or semantic information embedded within an electronic document. Upon identifying the TOC entries, the balance of the content in the page that is unidentified may be labeled as negligible text.

With continued reference to FIG. 16, structural attributes of the TOC entries are determined, as indicated at block 1620. These structural attributes are described more fully below with reference to sub-engines 340, 350, and 360 of FIG. 3. Next, the identified TOC entry is verified against page content in the target section of the electronic document. With more specificity, a determination of whether the TOC entry includes a reference character string is performed, as indicated at block 1640. If not, then the identification of the TOC entry is not verified, as indicated at block 1650. If a reference character string is present, the page content of the target section is compared against the character strings in the TOC entry, as indicated at block 1670. If comparable, then the accuracy of the identification of the TOC entry is verified, as indicated at block 1670. If not comparable, then the structural attributes of the character strings are reevaluated, as indicated at block 1690.

By way of example, and not limitation, the identity and verification of TOC entries is illustrated in FIGS. 5 and 6. With reference to FIG. 5, the chapter name number 520, the chapter title 530, the chapter separator 540, and the page number 550 combine to form a TOC entry 510, thus satisfying one set of criteria from above. Next, the identification of the TOC entry 510 is verified by comparing the elements 520, 530, 540, and 550 against a target section 610 (see FIG. 6). Here, the chapter title 630 and chapter name number 620 indicated in FIG. 6 are comparable, at least in some aspects, to the chapter title 530 and chapter name number 520 indicated in FIG. 5. Thus, as the character strings in the TOC entry 510 are comparable to the page content of the target section 610, the identification of the TOC entry is verified.

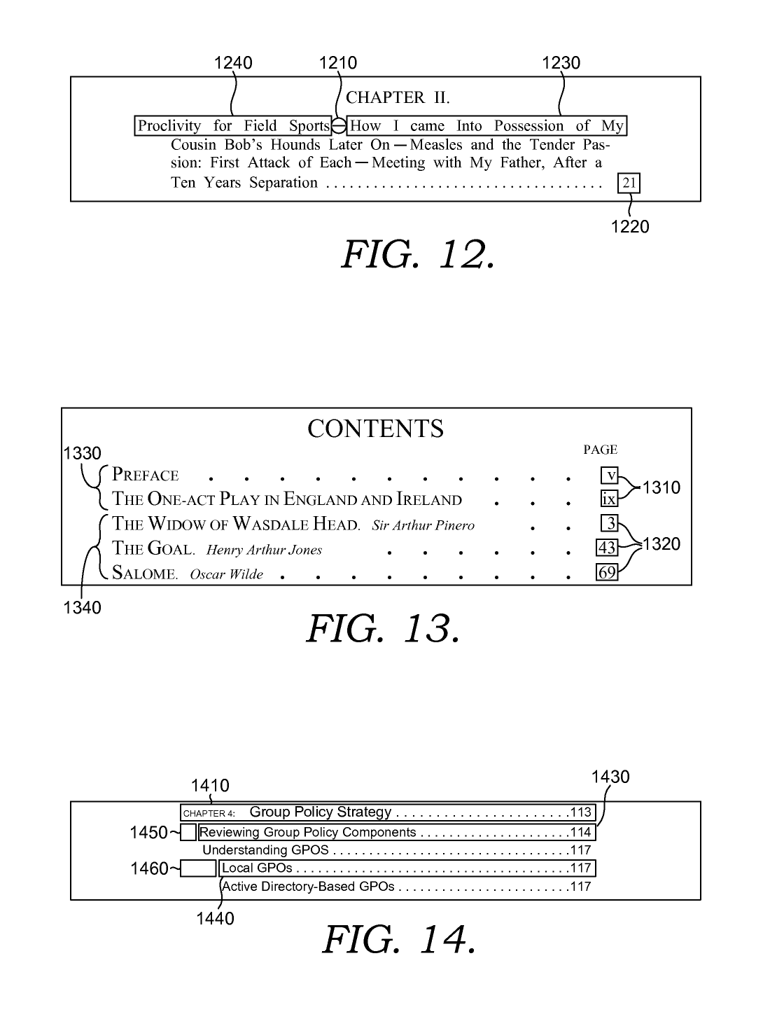

Returning now to FIG. 3, the line-type sub-engine 340 will now be described. The line-type sub-engine 340 is configured to determine whether a TOC entry may be classified as beginning on the line being analyzed or continuing from a previous line. This determination is carried out by utilizing a scoring technique that considers a variety of factors. One example of the implementation of which is shown in FIG. 12. One factor considered is whether there is a non-alphabetic separator 1210 that divides a first TOC entry 1240 and a second TOC entry 1230. A second factor considered is whether a chapter page number 1220 resides on a different line than other TOC entries 1230, 1240. Although two factors are discussed herein and depicted with specificity in FIG. 12, it should be understood and appreciated that other textual data and/or semantic information (e.g., number of characters strings, chapter titles, chapter separators, etc., in a line) may be considered. In one embodiment, the scoring technique compiles data generated by the factors and assigns a score to the TOC entry. Based on the score, the TOC entry is classified as either a beginning or continuation, and labeled accordingly.

Returning to FIG. 3, the entry-class sub-engine 350 will now be described. The entry-class sub-engine 350 is configured to determine whether a TOC entry may be classified as an introductory entry, which points to an introduction, preface, dedication, etc., of the electronic document, or a regular entry, which points to a main-body section of the electronic document. This distinction is made by carrying out a series of tests, one implementation of which is shown in FIG. 13. One test determines whether the TOC entry 1330 is associated with a reference character string, or target page number 1310, displayed as roman numeral. If so, the TOC entry is preliminarily classified as introductory. Alternatively, if the TOC entry 1340 is associated with a target page number displayed as an arabic numeral 1320, the TOC entries 1340 are classified as regular. A second test evaluates the preliminary classifications of the first test to determine whether introductory TOC entries 1330 are positioned above the regular TOC entries 1340. If this second test is satisfied, the TOC entries are labeled according to the preliminary classifications. Although two test are discussed herein and depicted with specificity in FIG. 13, it should be understood and appreciated that other textual data and/or semantic information may be considered.

Returning again to FIG. 3, the depth-level sub-engine 360 will now be described. The depth level sub-engine 360 is configured to determine and assign a depth level of the TOC entry within a hierarchical structure of the TOC portion of the electronic document. This determination is made by creating a horizontal indention index. Initially, the horizontal indention for each TOC entry is determined. In one embodiment the horizontal indention is based on the coordinate position, or horizontal location as discussed above, of each TOC entry. As shown in FIG. 14, no horizontal indention is present with relation to TOC entry 1410. An intermediately-sized horizontal indention 1450 is associated with TOC entry 1430, while a substantial horizontal indention 1460 is associated with TOC entry 1440. Accordingly, the TOC entries 1410, 1430, and 1440 would be assigned differing depth levels. An exemplary assignment of depth levels 860 to TOC entries is illustrated at FIG. 8. In this embodiment, the higher the value of the depth level, the lower the level of the TOC entry within the TOC hierarchical structure. Although a single determination is discussed herein and depicted with specificity in FIG. 14, it should be understood and appreciated that other textual data and/or semantic information may be utilized to make a depth level determination.

Referring back to FIG. 3, the linking sub-engine 370 will now be discussed. The linking sub-engine performs 370 at least two distinct functions. The first function generally involves linking the page numbers of the electronic document, typically extracted by the antecedent engine(s) 234 (see FIG. 2). In one embodiment, linking includes mapping the reference character strings, target page numbers, and the like, to the appropriate page numbers of the document. Advantageously, a robust and manageable TOC is created that allows a user to search and/or navigate through an electronic document on a user interface by simply selecting a TOC entry of interest.

The second function generally involves storing, or gluing, the labels appended to the character strings and/or TOC entries in association therewith. In one embodiment, a single label selected from the predetermined set of TOC-architecture labels is stored in association with each character string, while a label determined by each of the sub-engines 340, 350, and 360 is stored in association with each TOC entry. These stored labels, TOC entries, and character strings may be serialized according to an intermediate OCRML format scheme (e.g., book markup language), and transferred to the subsequent engine(s) 238 (see FIG. 2) via the engine-interface manager 232 (see FIG. 2).

In embodiments, the linking sub-engine 370 is able to verify its map of the reference character strings to an appropriate page number utilizing titles on the target page. By way of example, verification includes comparing a character string, and information associated therewith, to the title on the target page linked to that character string. Accordingly, the verification step can correct false links, where the page number or TOC entry is misread by the OCR technology. Further, verification checks the individual characters in the TOC entry against the title in the target page, typically if the TOC entry is identified as a chapter name, to ensure that the character string correspond and to ensure that the TOC is properly labeled.

As can be understood, embodiments of the present invention provide computerized methods and systems, and computer-readable media having computer-executable instructions embodied thereon, for classifying character strings of a table-or-contents (TOC) portion of an electronic document. Image-scanning devices employ technology (e.g., optical character recognition) for identifying textual data on a page of an electronic document, typically scanned from a physical book or article. Upon receiving textual data (for instance, character strings, position of the character strings, and layout and/or shape characteristics of the character strings) extracted from the electronic document, semantic information may be extracted, through a series of tests, from the textual data. This semantic information may be utilized to determine a classification of character strings within the electronic document, typically via a scoring mechanism. The classification may include appending a label to the character strings and storing. In this regard, the stored classification of the character strings enriches the electronic document with format information that enhances navigation thereof. In this way, the classified character strings may be advantageously leveraged to improve relevance of keyword searches over the Internet.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-storage media having computer-executable instructions embodied thereon that, when executed, perform a method for classifying character strings of a table-of-contents (TOC) portion of an electronic document, the method comprising:
receiving textual data extracted from the electronic document, the textual data comprising one or more character strings of the TOC portion of the electronic document;
extracting semantic information from the textual data of the identified TOC portion;
executing a classification procedure to determine at least one appropriate classification for the one or more character strings of the TOC portion by analyzing the semantic information;
appending one or more labels, selected from a predetermined set of TOC-architecture labels, to the one or more character strings according to the at least one appropriate classification; and
storing the one or more labels in association with the one or more character strings.

2. The one or more computer-storage media of claim 1, wherein the textual data further comprises at least one of: position values, on a page of the electronic document, associated with the one or more character strings; or layout characteristics, and shape characteristics, of the one or more characters strings.

3. The one or more computer-storage media of claim 2, wherein the classification procedure further comprises:
identifying one or more TOC entries within the TOC portion of the electronic document, the one or more TOC entries comprising one or more character strings; and
determining structural attributes of the one or more TOC entries based on the semantic information.

4. The one or more computer-storage media of claim 3, wherein the classification procedure further comprises:
determining whether the one or more TOC entries include a reference character string that targets a section of the electronic document;
if a reference character sting is provided, comparing page content within the section to the one or more character strings associated with the one or more TOC entries; and
verifying the accuracy of the identification of the one or more TOC entries upon determining that the page content corresponds with the associated one or more character strings.

5. The one or more computer-storage media of claim 2, wherein extracting semantic information from the textual data of the identified TOC portion comprises organizing the one or more character strings into groups upon recognizing the shape characteristics and the layout characteristic of the one or more character strings.

6. The one or more computer-storage media of claim 1, wherein the classification procedure comprises:
performing one or more categorization tests that utilize the extracted semantic information, wherein each of the one or more categorization tests relates to a respective label in the predetermined set of TOC-architecture labels; and
calculating at least one score based on results of each of the one or more categorization tests, wherein the score indicates a correlation between the respective label and the one or more character strings.

7. The one or more computer-storage media of claim 6, wherein performing the one or more categorization tests comprises:
executing one or more evaluation passes of the one or more character strings; and
adjusting the score incrementally based upon results of each of the one or more evaluation passes.

8. The one or more computer-storage media of claim 7, wherein the one or more evaluation passes comprise matching the semantic information associated with the one or more character strings against predefined layout characteristics and shape characteristics.

9. The one or more computer-storage media of claim 7, wherein adjusting the score incrementally is facilitated by a scoring function, the scoring function comprising:
score[n+1]=(score[n]*mulF)+addF,
wherein:
n indicates the iterative number of evaluation passes performed;
the multiplicative coefficient is mulF;
the additive coefficient is addF; and
score[n] represents a value of the score upon performing n number of evaluation passes; wherein the value of the score is reevaluated, utilizing the scoring function, incident to the completion of each of the one or more evaluation passes.

10. The one or more computer-storage media of claim 9, wherein the multiplicative coefficient and the additive coefficient are assigned numerical values based on the significance of the predefined layout characteristics and shape characteristics utilized in each of the one or more evaluation passes.

11. The one or more computer-storage media of claim 10, wherein the numerical values of the multiplicative coefficient and the additive coefficient are automatically trained according to a machine-learning framework to improve the accuracy of correlation between the respective label and an actual classification of the one or more character strings.

12. The one or more computer-storage media of claim 6, wherein the classification procedure further comprises comparing the at least one score calculated based on the results of each of the one or more categorization tests to determine which respective label in the predetermined set of TOC-architecture labels correlates to the one or more character strings.

13. A computer system for determining a structure of a table-of-contents (TOC) portion of an electronic document, the system comprising:
a converter component for receiving textual data extracted from the TOC portion the electronic document, the textual data comprising one or more TOC entries;
a TOC engine for classifying one or more elements within the one or more TOC entries of the electronic document, the TOC engine comprising:
a featurizer tool for extracting semantic information from the textual data; and
a word-label sub-engine for determining at least one appropriate classification for the one or more elements by analyzing the semantic information, and for appending one or more labels, selected from a predetermined set of architecture labels, to the one or more elements according to the at least one appropriate classification; and
a merge engine for storing the one or more labels in association with the one or more elements.

14. The computer system of claim 13, further comprising one or more antecedent layout engines for deriving format information from the electronic document based on an analysis of the textual data, the format information including an identification of the TOC portion of the electronic document.

15. The computer system of claim 14, further comprising an engine-interface manager for conveying the format information between the one or more antecedent layout engines and the TOC engine, wherein the word-label sub-engine of the TOC engine utilizes the format information when executing the classification procedure.

16. The computer system of claim 13, wherein the merge engine is further configured to attach an internal link to the one or more TOC entries, wherein an Internet user is directed to a targeted section of the electronic document upon selection of the internal link.

17. The computer system of claim 13, the TOC engine further comprising one or more classification sub-engines that determine structural attributes of the one or more TOC entries based on the extracted semantic information.

18. The computer system of claim 17, wherein the structural attributes comprises an indication of a number of lines of page content that each of the one or more TOC include, an indication of whether each of the one or more TOC entries reference an introductory section or a main-body section of the electronic document; and an indication of a level-of-depth value.

19. The computer system of claim 13, wherein appending one or more labels, selected from a predetermined set of architecture labels, to the one or more elements according to the at least one appropriate classification comprises selecting from a predetermined set of at least one of table-of-content architecture labels, bibliography architecture labels, or index architecture labels.

20. A computerized method for classifying character strings within electronic documents, the method comprising:
receiving textual data extracted from an electronic document, the textual data comprising one or more character strings, wherein the textual data comprises position values, layout characteristics, and shape characteristics, associated with the one or more characters strings;
deriving semantic information from the textual data, wherein deriving semantic information comprises organizing the one or more character strings into groups upon recognizing the shape characteristics and the layout characteristic of the one or more character strings;
performing one or more categorization tests that utilize the derived semantic information, wherein each of the one or more categorization tests relates to a respective label in a predetermined set of architecture labels, wherein performing the one or more categorization tests comprises:
executing one or more evaluation passes on the one or more character strings, wherein the one or more evaluation passes comprise matching the semantic information associated with the one or more character strings against predefined layout characteristics and predefined shape characteristics; and
incrementally adjusting a temporary score, associated with the one or more character strings, based upon results of each of the one or more evaluation passes, wherein adjusting the temporary score is facilitated by a scoring function that receives results determined by the one or more evaluation passes;
calculating at least one character-string score based on results determined by each of the one or more categorization tests and the temporary score;
appending one or more labels to the one or more character strings according to the at least one character-string score; and
serializing the one or more labels in association with the one or more character strings; and
training the scoring function according to a correlation between the one or more labels and an actual classification of the one or more character strings.
